(19) United States
(12) Patent Application Publication
(10) Pub. No.: US 2025/0196091 A1
(43) Pub. Date: Jun. 19, 2025

(54) MAGNETIC MESOPOROUS MATERIALS BASED ON SILICA (3MS)

(71) Applicants: UNIVERSITÉ DE BOURGOGNE, Dijon (FR); L'INSTITUT AGRO DIJON, Dijon (FR); CENTRE NATIONAL DE LA RECHERCHE SCIENTIFIQUE, Paris (FR)

(72) Inventors: Ali ASSIFAOUI, Dijon (FR); Frédéric BOUYER, Perrigny-lès-Dijon (FR); Laroussi CHAABANE, Dijon (FR)

(21) Appl. No.: 18/849,421

(22) PCT Filed: Mar. 21, 2023
(86) PCT No.: PCT/FR2023/050395

§ 371 Date: Sep. 20, 2024

(30) Foreign Application Priority Data
Mar. 23, 2022 (FR) FR2202558

(51) Int. Cl. B01J 20/10; B01D 15/08; B01J 20/28; B01J 20/30; B01J 20/32; B01J 20/34; B03C 1/01; B03C 1/28

(52) U.S. Cl. CPC B01J 20/103; B01D 15/08; B01J 20/28009; B01J 20/28061; B01J 20/28064; B01J 20/28071; B01J 20/28073; B01J 20/28076; B01J 20/28083; B01J 20/3064; B01J 20/3071; B01J 20/3085; B01J 20/3204; B01J 20/3219; B01J 20/3259; B01J 20/3433; B01J 20/3475; B03C 1/01; B03C 1/28; B03C 2201/18

(57) ABSTRACT

The invention relates to a magnetic mesoporous material based on functionalised silica (3MS-f), the method comprising the steps of: i) hydrolysing and precondensing, in an acid medium, a silica precursor (SiO₂) in the presence of a porogen compound having the formula (POE)ₙ-(POP)ₘ-(POE)ₙ wherein: -POE is a polyoxyethylene block; -POP is a polyoxypropylene block; -n is equal to 20 or 106 and -m is equal to 70; ii) incorporating silica-coated superparamagnetic iron nanoparticles into the precondensed mixture obtained in step i) and continuing the condensation; iii) removing the porogen agent from the obtained condensed structure, whereby an organised magnetic mesoporous material based on silica (3MS) is obtained; iv) functionalising the material (3MS) obtained in the preceding step by covalently grafting at least one reactive function that is capable of forming a weak bond with at least one organic molecule of interest (MIO), the weak bond being selected in particular from among electrostatic bonds between oppositely charged groups such as carboxylate/ammonium, phosphonate/ammonium or sulphonate/ammonium and hydrophobic bonds such as bonds between alkyl chains or between aromatic groups; v) optionally, recovering the functionalised magnetic mesoporous material based on silica (3MS-f) obtained in the preceding step.

### FIELD OF THE INVENTION

The present invention relates to a method for preparing functionalised Magnetic Mesoporous Materials based on Silica (3MS-f), to Magnetic Mesoporous Materials based on Silica (3MS), in particular functionalised (3MS-f), able to be obtained with this method, and to use thereof for isolating and concentrating Organic Molecules of Interest (OMIs) via application of a magnetic field.

### TECHNICAL BACKGROUND

The agri-food, agricultural, wine-growing industries generate a large quantity of residues or organic waste, also known as by-products, which can be upgraded by extracting molecules of interest therefrom having high added value (proteins, polypeptides, polyphenols, polysaccharides, colourants, . . . ) for different applications, in particular for the cosmetic, pharmaceutical or agri-food industries.

There exist several modes of extraction (enzymatic, chemical, physical . . . ) allowing these molecules of interest to be isolated. However, they most often have recourse to high performance liquid chromatography (HPLC) for separation via chemical affinity, or to dialysis membranes for separation by size. The molecules of interest separated by these usual methods are therefore in solution, but in very low concentration (a few ppm). It is generally necessary therefore, after these conventional separation steps, to provide for several concentration steps (centrifugation, filtration, drying, . . . ) to remove the solvent. Typically, for a concentration of recovered product of interest in the region of 10 mg/L with these usual extraction techniques, it is necessary to remove water which represents ˜99.99% of total weight, corresponding to hundreds of litres of solvent for the recovery of only a few grams of said molecule of interest. These last two steps are highly energy-intensive having a major impact not only on the environment but also on the overall costs of the isolating method, and ultimately therefore on the price of the isolated molecule of interest.

As a result, current separation/isolation methods considerably hinder the upgrading of by-products from the agri-food, agricultural or wine-growing, wine-producing industries in particular.

There is therefore a true need to provide a method allowing the isolation and concentration of molecules of biological interest, the method being less costly, more environmentally-friendly and/or faster to implement, promoting the recovery of by-products in particular.

### SUMMARY OF THE INVENTION

Magnetic mesoporous materials based on Silica (3MS) and functionalised (3MS-f) have now been discovered which combine chemical and size selectivity to allow easy, selective and fast isolation of organic molecules of interest having functional groups (—NH₂, —COOH, . . . ) within their structure.

Also, compared with conventional extraction techniques, they bring a considerable reduction in the quantities of solvent used and hence in the energy required for isolation of these molecules, thereby reducing the impact both on the environment and on the final cost of the isolated molecules of interest.

In addition, these materials can be regenerated and therefore recycled after use in the isolation method of the molecule of interest, further reducing the environmental impact of the method.

More particularly, the inventors have developed a method whereby superparamagnetic particles of iron oxide can be incorporated in Ordered Mesoporous Structures (OMS) of SBA-15 or SBA-16 type, whilst preserving the porosity and specific surface area that are characteristic of these OMS structures and also the superparamagnetic properties of the incorporated iron oxide particles.

The Materials (3MS) obtained can subsequently be functionalised according to the target OMI molecule that it is desired to isolate or concentrate, by adding a reactive function, particularly inside the pores, that is able to react with at least one of the functional groups contained in the chemical structure of the target molecule, to form a weak bond, especially electrostatic bond, with the target molecule. The resulting material (3MS-OMI), due in particular to the superparamagnetic properties thereof, can then be concentrated and recovered by means of a magnet; the molecule of interest OMI can thereafter be released via rupture of the 3MS-OMI bond, and the regenerated material (3MS-f) can be reused in a new isolation and concentration cycle of an OMI.

For example, to isolate an OMI molecule carrying a carboxylic acid functional group (—COOH), the 3MS material can be functionalised via fixation of a reactive function (—NH₂) to form a functionalised material (3MS-f), here a material (3MS-NH₃⁺) able to form an electrostatic bond between the carboxylate functions (COO⁻) of the target OMI.

The inventors have therefore been able to show that when these functionalised materials (3MS-f) are added during or at the end of the extraction method, they are capable of preferably attaching to an organic molecule of interest by acting both on the pore size of the mesoporous structure, allowing exclusion of those molecules contained in the extract having greater steric hindrance than that of the pore size and hence of the target OMI molecule, and by acting on the chemical affinity of the OMI molecule for the reactive function fixed inside the pores, translating as the formation of a weak (3MS-OMI) bond.

Once the organic molecule of interest is attached onto the inorganic material (3MS-OMI), a magnetic field can be applied to accelerate sedimentation of the 3MS-OMIs and concentration thereof.

After removal of the supernatant, the 3MS-OMIs can be washed with aqueous solutions, acid or basic, to cause a change in pH and release the target OMI molecule, and at the same time to regenerate the (3MS-f)s which can be recycled and reused for further OMI extractions.

These materials (3MS-f) advantageously allow limiting of the quantities of solvent needed to isolate the target molecules, and therefore also the cost of the drying step.

Additionally, the selectivity of these materials for the OMI molecule it is desired to isolate can advantageously be modulated according to pore size and functionalisation of the materials (3MS-f)

The invention therefore firstly concerns a method for preparing a functionalised magnetic mesoporous material based on silica (3MS-f), said method comprising the steps of:
i) Hydrolysing and precondensing a precursor of silica (SiO₂), in an acid medium, in the presence of a porogen compound of formula (POE)ₙ-(POP)ₘ-(POE)ₙ wherein:
   POE is a polyoxyethylene block,
   POP is polyoxypropylene block,
   n is 20 or 106, and
   m is 70;
ii) Incorporating silica-coated superparamagnetic iron nanoparticles in the precondensed mixture obtained at step i), and continuing condensation;
iii) Removing the porogenic agent from the condensed structure obtained, whereby an ordered magnetic mesoporous material based on silica is obtained (3MS);
iv) Functionalising the material (3MS) obtained at the preceding step by covalently grafting at least one reactive function able to form a weak bond with at least one organic molecule of interest (OMI), said weak bond being chosen in particular from among electrostatic bonds between oppositely charged groups such as carboxylate/ammonium, phosphonate/ammonium, sulfonate/ammonium, and hydrophobic bonds such as bonds between alkyl chains or between aromatic groups.
v) Optionally, recovering the functionalised magnetic mesoporous material based on silica (3MS-f) obtained at the preceding step.

In some embodiments of the method:
the silica precursor is a compound comprising at least one alkoxysilane group, preferably a compound Si(OR)₄ with R, the same or different, being a C₁-C₄ alkyl group;
step ii) is conducted until reaching a condensation rate of the silica precursor higher than or equal to 80%;
step iii) is performed by extracting the porogenic agent with a solvent, in particular using a Soxhlet extractor;
said at least one reactive function is grafted at step iv) by contacting the material 3MS with a compound of formula:

(R³O₎₄₋ₙSi-(L-X)ₙ (I)
where:
X is a reactive function chosen in particular from among:
   a polar protic function chosen from among an amine or carboxylic acid, phosphonic acid or sulfonic acid, and the salts thereof; of
   a hydrophobic group chosen from among alkyl or aromatic groups, phenyl in particular,
L is a divalent spacer group chosen in particular from among a bond, C₁-C₆ alkylene group, C₅-C₇ arylene group, aralkylene, alkylarylene group,
R³ is H or C₁-C₆ alkyl group,
n is 1, 2 or 3.

In a second aspect, a further subject of the invention is a functionalised magnetic mesoporous material based on silica (3MS-f), able to be obtained with the method of the invention.

In a third aspect, the invention concerns a functionalised magnetic mesoporous material based on silica (3MS-f), characterised in that it comprises:
a) a mesoporous material of SBA-15 or SBA-16 type;
b) one or more superparamagnetic iron particles, particularly silica-coated;
c) at least one reactive function able to form a weak bond with at least one organic molecule of interest (OMI), said weak bond particularly being chosen from among electrostatic bonds between oppositely charged groups, and hydrophobic bonds such as bonds between alkyl groups or between aromatic groups, phenyl in particular,

In a fourth aspect, the invention concerns a non-functionalised magnetic mesoporous material (3MS) based on silica able to be obtained with steps i), ii) and iii) of the method of the invention.

In some embodiments of the functionalised (3MS-f), or non-functionalised (3MS) magnetic mesoporous materials based on silica of the invention:
the specific surface area S_{BET} of the material (3MS-f) measured according to the BET method, is between 400 and 1000 m²/g, in particular between 400 and 800 m²/g;
the pore volume of the material (3MS-f) is between 0.7 and 1.1 mL/g, in particular between 0.8 and 1 mL/g;
the mean pore diameter is between 5 nm and 11 nm.

In a fifth aspect, the invention concerns the use of a functionalised magnetic mesoporous material based on silica (3MS-f), to isolate, concentrate and/or release an organic molecule of interest (OMI).

In some embodiments of this use, the organic molecule of interest(I) is chosen from among amino acids, polyphenols, polypeptides, proteins and oligosaccharides (OS).

In a further aspect, the invention concerns a method for isolating or concentrating an organic molecule of interest (OMI), comprising the steps of:
a) Contacting the mixture containing the OMI to be isolated or concentrated, with a material (3MS-f) of the invention;
b) Separating the mixture and recovering the material (3MS)-(OMI) formed at the preceding step; and optionally
c) Breaking the bond between the material (3MS) and the (OMI), whereby the (OMI) is released and recovered, and the material (3MS-f) is regenerated.

In a still further aspect, the invention concerns a magnetic mesoporous material based on silica (3MS)-(OMI) able to be obtained at step a) and optionally b) of the method for isolating or concentrating an organic molecule of interest (OMI) of the invention.

Other characteristics, aspects, objectives and advantages of the present invention will become more clearly apparent on reading the following description.

It is specified that the expressions “between . . . and . . . ” and “from . . . to . . . ” used herein are to be construed as including each of the indicated limits.

### BRIEF DESCRIPTION OF THE FIGURES

FIG. 1 is a schematic illustrating the synthesis of the mesoporous silica 3MS.

FIG. 2 is a schematic illustrating the functionalisation of the mesoporous silica 3MS by a propylamine group.

FIG. 3 shows the spectrum obtained by X-ray diffraction of a material (3MS-f) of the invention.

FIG. 4 gives the thermogravimetric analysis (TGA) of the materials 3MS-fand 3MS of the invention.

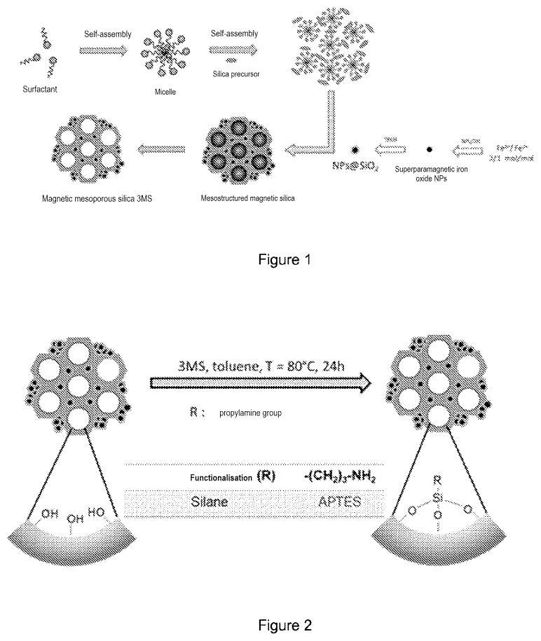

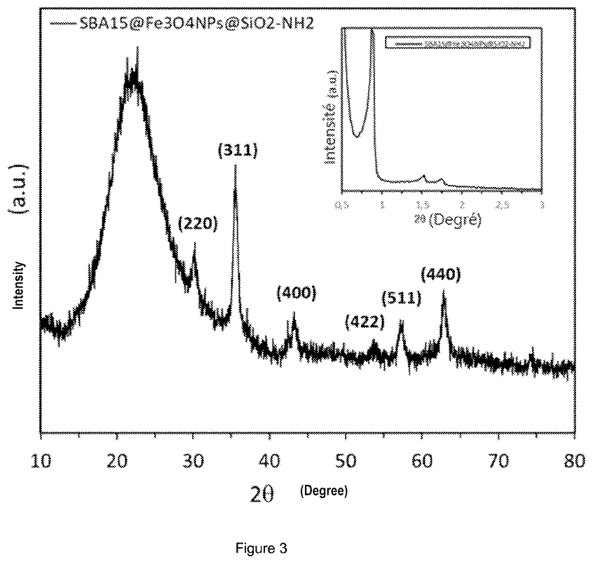

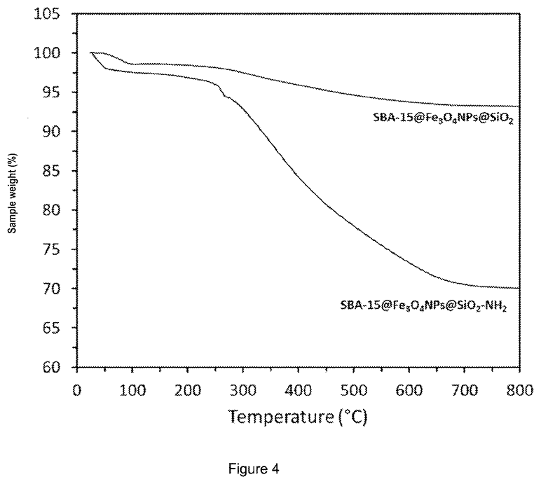

### DETAILED DESCRIPTION

The invention will now be described in more nonlimiting detail in the following description.

By “ordered mesoporous silica” (OMS) or “ordered mesoporous structure” it is meant a structure composed of a scaffold in amorphous silica delimiting well-ordered channels and/or cavities of regular size. They are characterised by a pore size of 2 to 50 nm, and by a high specific surface area at times greater than 1000 m²./g⁻¹. Ordered mesoporous silicas are often synthesised according to a Cooperative Templating Mechanism (CTM) the principle of which is to hydrolyse and then condense an inorganic precursor (silane) around surfactant micelles in an aqueous solution. Depending on the type of surfactant used (ionic or non-ionic) and the reaction medium (acid or basic) in which synthesis takes place, different families of materials can be obtained (M41S, SBA-n, HMS, MSU . . . ).

The (3MS) or (3MS-f) materials of the invention belong to the SBA-n family (D.Zhao, J. Feng, Q.Huo, N.Melosh, G.H. Fredrickson, B.F. Chmelka, G.D. Stucky. Science. 1998, 279, 548) and more particularly to the OMS of SBA-15 or SBA-16 type. This family has larger pores and thicker walls imparting greater hydrothermal stability than the M41S family generally used.

By “mesoporous material” it is meant a material including pores having a diameter of between 2 nm and 50 nm, in particular between 2 and 30 nm.

By “alkyl” it is meant a linear or branched, saturated hydrocarbon group of formula CₙH₂ₙ₊₁ where n is the number of carbon atoms.

### Method for Preparing a Material (3MS-f)

In a first aspect, the invention concerns a method for preparing a functionalised magnetic mesoporous material based on silica (3MS-f), said method comprising the steps of:
i) Hydrolysing and precondensing a precursor of silica (SiO₂), in an aqueous acid medium, in the presence of a porogen compound of formula (POE)ₙ-(POP)ₘ-(POE)ₙ, wherein:
   POE is a polyoxyethylene block,
   POP is a polyoxypropylene block,
   n is 20 or 106, and
   m is 70;
ii) Incorporating silica-coated superparamagnetic iron oxide nanoparticles in the precondensed mixture obtained at step i), and continuing condensation;
iii) Removing the porogenic agent from the condensed structure obtained, whereby an ordered magnetic mesoporous material based on silica is obtained (3MS);
iv) Functionalising the material obtained (3MS) at the preceding step by covalently grafting at least one reactive function able to form a weak bond with at least one organic molecule of interest (OMI), said weak bond being chosen in particular from among electrostatic bonds between oppositely charged groups, and hydrophobic bonds such as bonds between aromatic groups, or alkyl chains;
v) Optionally, recovering the functionalised magnetic mesoporous material based on silica (3MS-f), obtained at the preceding step.

By “aromatic group” it is meant a system of mono-or bicyclic hydrocarbon aromatic ring(s), substituted or non-substituted, and particularly having 6 to 12 carbon atoms in the ring. For example, mention can be made of phenyl and naphthyl. The preferred aryl groups comprise non-substituted or substituted phenyl and naphthyl groups. The definition of the term “aryl” encompasses fused ring systems including for example ring systems in which an aromatic ring is fused with a cycloalkyl ring. Examples of said fused ring systems comprise indane, indene and tetrahydronaphthalene for example.

By “alkyl chain” or “alkyl group” it is meant a straight or branched chain of formula —CₙH₂ₙ₊₁ preferably having 6 to 12 carbon atoms, such as 3-methylpentyl, 2,2-dimethylbutyl, 2,3-dimethylbutyl, hexyl, octyl, etc.

### Step I)

The porogenic agent used at step i) is either the triblock copolymer Pluronic® P123 of formula POE₂₀POP₇₀POE₂₀, or Pluronic® F127 (also called Poloxamer 407) of formula POE₁₀₆POP₇₀POE₁₀₆.

In particular, as reported in the literature, Pluronic® P123 of formula POE₂₀POP₇₀POE₂₀ allows the synthesis of Ordered Mesoporous Structures (OMS) of SBA-15 type having 2D-hexagonal structure (P6mm), while Pluronic® F127 gives access to OMS structures of SBA-16 type having 3D-cubic structure (Im3m).

OMS materials of SBA-15 type reported in the literature generally have large pores ranging from 50 to 300 Å that are perfectly calibrated and modulated by acting on the presence of pore expanders, synthesis conditions, specific surface area possibly reaching 1000 m²/g, and thick walls (several nanometres), imparting good hydrothermal stability to the materials.

OMS materials of SBA-16 type reported in the literature have similar volumetric properties to SBA-15s.

The hydrolysis and precondensation step a), comprises the steps of:
i₁) dispersing the porogenic agent in an acid medium, in particular at a temperature of between 30 and 50° C.;
i₂) adding, dispersing and precondensing the silica precursor in the mixture obtained at step i₁), in particular at a temperature of between 90° C. and 150° C.

Step i₁) is particularly conducted at acid pH. The concentration of strong acid can be between 1 mol/L and 2 mol/L, in particular about 1.6 mol/L.

The acid used at step i₁) is particularly a mineral acid such as hydrochloric acid.

Depending on embodiments, the molar concentration of the porogenic agent in water is between 3 mol/L and 8 mmo/L, in particular between 4.5 mmo/L and 6 mmo/L.

The purpose of step i₁) is to solubilise the porogenic agent in the aqueous solution. This step is typically conducted under agitation and/or for a time tᵢ₁ of between 1 and 3 hours.

Step i₂) comprises the addition of the silica precursor to the solution of porogenic agent obtained at step i₁). This addition is generally performed under agitation.

The silica precursor can be a compound comprising at least one alkoxysilane group, preferably a compound Si(OR)₄ where R, the same or different, is a C₁-C₄ alkyl group. As examples of silica precursor, mention can be made of tetraethylorthosilicate (TEOS), tetramethoxysilane (TMOS).

The molar ratio of silica precursor to porogenic agent may vary according to pore size, pore volume and/or the specific surface area it is desired to obtain. Preferably, it is between 50 and 200, in particular between 50 and 100.

Step i₂) can be performed up until the formation of a dispersed solid phase, visible to the naked eye, corresponding to the formation of silica particles in suspension resulting from hydrolysis and condensation of the precursor, and translating as opacification of the reaction mixture. The progress of the turbidity of the mixture can also be continuously monitored by spectrophotometry e.g. with a turbidimeter or opacimeter.

Alternatively, step i₂) can be performed up until a condensation rate of the silica precursor of at least 40% is reached.

By “precursor condensation rate” it is meant the molar ratio of the number of condensed bonds to the number of condensable bonds. This condensation rate can be monitored and calculated by NMR.

The inventors have observed that it is important not to add the superparamagnetic iron oxide particles before precondensation of the silica precursor, so as not to jeopardise formation of the ordered mesoporous structure of SBA-15 or SBA-16 type. They were able to ascertain that when these iron oxide particles are added at the same time as the silica precursor to the aqueous solution containing the porogenic agent P123, the solid phase obtained after condensation of the precursor does not exhibit an ordered mesoporous structure of SBA-15 type.

Also, it is preferable to add the superparamagnetic iron oxide particles before condensing of the silica precursor has reached a stage that is too advanced, to promote homogeneous distribution of the particles within the ordered mesoporous structure.

As is conventional, step i₂) is performed for a time ti₂ of between 1 and 3 hours.

### Step II)

Step ii) corresponds to adding of the superparamagnetic iron oxide particles (Fe₃O₄).

These iron oxide particles can be prepared following methods well known in the prior art and in particular the method described in Massart et al., Preparation of aqueous magnetic liquids in alkaline and acidic media, IEEE Transactions on Magnetics, Vol. Mag-17, No 2, March 1981.

The superparamagnetic iron oxide particles (Fe₃O₄) generally have a size of about 5 to 10 nm. They are contained in the reaction medium in the form of aggregates of size less than 100 nm.

The particles used in the method are previously coated with a layer of silica for protection against the acid conditions required for synthesis of the ordered mesoporous structure.

This silica coating can be obtained with conventional methods such as the one described in: Preparation and Properties of Uniform Coated Colloidal Particles. VII Silica on Hematite, Journal of Colloid and Interface Science. Vol. 150. No 2, May 1992.

The method for preparing silica-coated superparamagnetic iron oxide particles can particularly comprise the steps of:
Contacting an aqueous suspension of superparamagnetic iron oxide particles with ammonia;
Adding a silica precursor to the mixture obtained at the preceding step; and
Recovering the silica-coated superparamagnetic iron particles obtained.

The thickness of the silica layer formed around the superparamagnetic iron particles may vary as a function in particular of the molar ratio between the superparamagnetic iron oxide particles and the silica precursor.

In some embodiments, the aggregates of superparamagnetic iron nanoparticles are coated with a silica layer having a thickness of between 1 and 10 nm, in particular between 2 nm and 5 nm.

In some embodiments, the superparamagnetic iron nanoparticles coated with a silica layer have a size of between 5 and 10 nm, and the aggregates have a size of less than 120 nm, generally of about 100 nm.

Advantageously, the silica coating on the iron oxide particles allows preserving of the magnetic properties of the particles throughout the method which entails particularly acidic conditions that are likely to dissolve the iron oxide nanoparticles.

Additionally, the coating promotes incorporation and fixing of the iron oxide particles within the ordered network of the mesoporous structure. The iron oxide particles are therefore less exposed and less likely to be degraded by the surrounding medium, compared with a configuration in which the iron oxide nanoparticles are solely fixed onto the surface of the mesoporous structure. Therefore the magnetic properties of the 3 MS material are better preserved over time.

Step II) can be conducted at a temperature Tᵢᵢ of between 70° C. and 100° C., in particular at 80° C.

The condensation step at step ii) is continued until reaching a condensation rate of the silica precursor that is higher than or equal to 60%.

The material (3MS) obtained can then be recovered. It is generally in the form of particles, in particular micro- or nanoparticles.

In some embodiments, prior to step iii), the suspension containing the material (3MS) obtained at step ii) is neutralised and washed, in particular up until conductivity close to that of water is obtained, typically less than 10 microsiemens/cm.

### Step III)

Step iii) comprises removal of the porogenic agent from the condensed structure obtained.

This removal is preferably performed by extracting the porogenic agent with a solvent, in particular using a Soxhlet extractor.

Contrary to calcination extraction methods, solvent extraction advantageously protects the superparamagnetic iron oxide particles against any degradation and allows the porogenic agent to be extracted without being deteriorated so that it can be reused/recycled to prepare new 3MS or 3MS-f materials.

Therefore, in one embodiment, the porogenic agent in solution in the extraction solvent is recovered and in particular is recycled by implementing step i) of the method of the invention.

### Step IV)

Step iv) comprises functionalisation of the material 3MS obtained, by at least one reactive function. This function is chosen in particular to obtain the forming of a weak bond, of electrostatic or hydrophobic type, with at least one of the functions carried by the molecule of interest, e.g. a carboxylic acid or amine function.

According to embodiments, at step iv) said at least one reactive function grafted onto the material 3MS obtained at step iii) is chosen from among:
a polar protic group chosen from among an amine or a carboxylic acid, phosphonic acid or sulfonic acid;
a hydrophobic group chosen from among aromatic groups particularly phenyl groups, or alkyl groups.

Said at least one reactive function can be grafted at step iv) by contacting the material 3MS with a compound of formula:

(R³O)₄₋ₙSi-(L-X)ₙ (I)

where:

X is a reactive function chosen in particular from among:
a polar protic function chosen from among an amine or carboxylic acid, phosphonic acid or sulfonic acid, or a salt thereof, or else
a hydrophobic group chosen from among aromatic groups particularly phenyl, or alkyl groups.
L is a divalent spacer group chosen in particular from among a bond, C₁-C₆ alkylene group, C₅-C₇ arylene group, aralkylene, alkylarylene group,
R³ is H or C₁-C₆ alkyl group,
n is 1, 2 or 3.

Therefore, the functionalisation step can be performed by condensing a compound comprising an alkoxysilane function, such as a compound of formula (I), with the silanol functions present on the surface of the material 3MS.

This functionalisation can be performed in a suitable organic solvent e.g. toluene. It is generally conducted at a temperature compatible with the molecule carrying the reactive function it is desired to graft i.e. at a temperature preventing degradation of this molecule and lower than the boiling point of the solvent. For example, functionalisation can be conducted at a temperature possibly of between 70° C. and 100° C.

### Step V)

Step v) comprises recovery of the functionalised material (3 MS-f) obtained at the preceding step.

The material (3MS-f) can be washed with an alcohol and dried.

### Materials (3MS-f) and (3MS)

In a second aspect, the invention concerns a functionalised magnetic mesoporous material based on silica (3MS-f) able to be obtained with the method of the invention.

In a further aspect, the invention concerns a functionalised magnetic mesoporous material based on silica (3MS-f) characterised in that it comprises:
a) An ordered mesoporous structure of SBA-15 or SBA-16 type;
b) One or more superparamagnetic iron particles, in particular silica-coated;
c) At least one reactive function able to form a weak bond with at least one organic molecule of interest (OMI), said weak bond being chosen in particular from among:
   an electrostatic bond based on carboxylate/ammonium, phosphonate/ammonium, or sulfonate/ammonium interactions;
   a hydrophobic bond based on interactions between aromatic groups, particularly phenyl, or alkyl groups.

In a still further aspect, the invention concerns a magnetic mesoporous material based on silica (3MS) able to be obtained at steps i), ii), iii) and iv) of the method of the invention. This material is useful as intermediary for preparation of the materials (3MS-f) of the invention.

Advantageously, the characteristics of these materials, such as functionalisation porosity, pore volume and/or specific surface area can be modulated according to the target molecule it is desired to isolate and/or the extraction medium in which it is contained, by acting in particular on the synthesis conditions of the method of the invention.

The specific surface area S_{BET} of the material (3MS-f) or (3MS) measured according to the BET method, can be between 400 and 1000 m²/g, in particular between 400 and 800 m²/g.

The pore volume of the material (3 MS-f) or (3 MS) can be between 0.4 and 1.1 mL/g, in particular between 0.8 and 1 mL/g.

The mean pore diameter of the material (3MS-f) or (3MS) can be between 5 nm and 11 nm. This diameter can be measured with methods well known in the field of mesoporous materials, and in particular by nitrogen physisorption.

### Use of the Materials (3MS-f) and (3MS)

In a still further aspect, the invention concerns the use of a functionalised magnetic mesoporous material based on silica (3MS-f) of the invention to isolate and/or concentrate an organic molecule of interest (OMI).

The organic molecule of interest (OMI) to be isolated and/or concentrated can be a molecule of plant origin e.g. derived from by-products of the agri-food industry, or from wine-growing or wine-producing by-products.

The use of materials (3MS-f) can therefore advantageously contribute towards upgrading the by-products of these industries.

The organic molecule of interest (OMI) to be isolated and/or concentrated can be a medicinal, cosmetic substance for example.

It can be chosen from among amino acids, polyphenols, polypeptides, proteins, oligosaccharides (OS).

### Method for Isolating and/or Concentrating an Organic Molecule of Interest (OMI)

In a further aspect, the invention concerns a method for isolating or concentrating an organic molecule of interest (OMI), comprising the steps of:
a) Contacting the mixture comprising the OMI to be isolated and/or concentrated with a material (3MS-f) of the invention, to form a material (3MS)-(OMI);
b) Separating the mixture and recovering the material (3MS)-(OMI) formed at the preceding step; and
c) Breaking the bond between the material (3MS) and organic molecule (OMI), whereby the (OMI) is released and recovered, and the material (3MS-f) is regenerated.

### (3MS-f) Functionalised with a Polar Protic Function

In one embodiment, the material (3MS-f) is functionalised with a polar protic function.

Step a) is then generally performed in an aqueous medium under pH conditions promoting the formation of an electrostatic bond between the reactive function of the material (3MS-f) and at least one function of the organic molecule of interest.

Step b) can advantageously be performed by applying an external magnetic field.

Step c) can accordingly by performed by adding an acid or basic solution to modify the pH of the aqueous solution and break the electrostatic bond between the material (3MS) and the molecule of interest (OMI).

### (3MS-f) Functionalised with a Hydrophobic Group

In another embodiment, the material (3MS-f) is functionalised with a hydrophobic group.

Step a) is then generally performed in an aqueous medium. The OMIs having a hydrophobic reactive function will react with a hydrophobic reactive function of the material (3MS-f) to form hydrophobic bonds.

Step b) can advantageously be performed by applying an external magnetic field.

Step c) can accordingly be carried out by immersing the recovered material (3MS-f) in an organic solution, an alcohol in particular or a ketone, to break the hydrophobic bond between the material (3MS) and the molecule of interest (OMI).

### Magnetic Mesoporous Silica-Based Material (3MS)-(OMI) Able to be Obtained with the Method of the Invention

In a further aspect, the invention concerns a magnetic mesoporous silica-based material (3MS)-(OMI) able to be obtained with step a) and optionally step b) of the method of the invention.

This material can be useful in particular for the storing and/or release of the OMI molecule.

### EXAMPLES

### Example 1: Preparation of a Material (3MS-f): (3MS-NH₂)

### Step 1: Synthesis of Superparamagnetic Iron Oxide Nanoparticles Fe₃O₄

Solution A: 10 mL of 0.150 M aqueous iron chloride (III) solution, 6H₂O, are prepared in a Schlenk tube under a stream of nitrogen.

Solution B: 10 mL of 0.075 M aqueous iron chloride (II) solution, 4H₂O, are prepared in a Schlenk tube under a stream of nitrogen.

Under mechanical agitation, both solutions A and B are simultaneously added to a three-necked flask under a stream of nitrogen and in the presence of a coolant. The mixture is brought to 80° C. At this temperature, 20 mL of ammonia at 2 mol/L are added. The mixture is left under agitation for 2 h at 80° C. The pH is about 12 (12±0.3).

The suspension is washed by centrifugation/redispersion several times to bring the conductivity of the solution to below 10 μS/cm.

The pH of the suspension is then lowered to pH 3 through dropwise addition of 2 M HCl. The size of the iron oxide aggregates is about 100 nm (measured by DLS, Malvern, Nano ZS, UK).

### Step 2: Coating the Iron Oxide Nanoparticles with a Silica Layer: Fe₃O₄@SiO₂

200 mg of iron oxide are taken from the suspension at pH 3 (volume sampled about 20 mL).

The sampled suspension is dispersed in an EtOH/water mixture (150 mL/40 mL) for 30 min under mechanical agitation.

3 mL of ammonia at 2 mol/L are added dropwise to the suspension, and the whole is left under agitation for 15 min.

300 mg of TEOS (tetraethyl orthosilicate) are added dropwise to the preceding mixture at ambient temperature. The whole is left under agitation 24 h at ambient temperature.

The suspension is afterwards washed several times with an ethanol/water mixture (250 mL/250 mL).

The size of the iron oxide aggregates is about 100 nm (measured by DLS, Malvern, Mamo ZS, UK).

### Step 3: Synthesis of Magnetic Mesoporous Silica: Fe₃O₄@SiO₂/SBA15

### Step 1: Synthesis

Preparation 1: 1.5 mg of P123 copolymer are dissolved in 40 mL of HCl at 2 mol/L, under mechanical agitation at 40° C. for 2 h.

3.12 g of TEOS are added dropwise to the solution under mechanical agitation. The solution is brought to 100° C. in a glass flask.

Preparation 2: 200 mg of Fe₃O₄@SiO₂ are dispersed in 9 mL of water and 1 mL of HCl at 1 mol/L, and left under agitation for 30 min at ambient temperature.

After leaving preparation 1 at 100° C. for 2 h (a milky solution is obtained), preparation 2 is added. The mixture is left at 100° C. for an additional 22 h.

The pH of the mixture is increased to pH 7 through the addition of sodium hydroxide (NaOH, 1 mol/L). The suspension is washed several times with cycles of centrifugation/redispersion until the conductivity of the suspension is close to that of pure water (conductivity<10 μS/cm).

### Step 2: Extraction of the Copolymer

The copolymer P123 is extracted from the silica particles in the presence of organic solvent (ethanol) for 48 h (Soxhlet extractor). The sample is subsequently oven-dried overnight at 80° C.

Characterization of the sample is performed by nitrogen physisorption at 77 K (Micromeritics ASAP 2020, Norcross, GA). The sample is previously degassed in a vacuum at 363 K. The specific surface area of the sample is calculated using the BET method in a pressure range P/P₀=0.06 to 0.25. Pore size distribution and pore volume are obtained with the BJH method using a volume of nitrogen adsorbed at P/P₀=0.75.

Physicochemical properties of the silica particles:
BET surface area: ˜800 m²/g;
pore volume: ˜1 g/mL;
pore diameter: ˜5.3 nm.

### Step 4: Functionalisation of the Magnetic Mesoporous Silica

200 mg of Fe₃O₄@SiO₂/SBA15 are dispersed in 10 ml of anhydrous toluene at 80° C. 2 mL of aminopropyltriethoxysilane (APTES, Sigma-Aldrich) are added dropwise. The mixture is held at 80° C. for 24 h, then washed 3 times in ethanol and oven-dried at 60° C. for 24 h. The sample is characterized by nitrogen physisorption at 77 K (Micromeritics ASAP 2020, Norcross, GA). The sample is previously degassed in a vacuum at 363 K. The specific surface area of the sample is calculated using the BET method over a pressure range P/Pₒ=0.06 to 0.25. Pore size distribution and pore volume are obtained with the BJH method using a volume of adsorbed nitrogen at P/P₀=0.75. For more information on the BJH method, particular reference can be made to the article: Barrett, EP; Joyner, LG; Halenda, PP “The Determination of Pore Volume and Area Distributions in Porous Substances I. Computations from Nitrogen Isotherms” Journal of the American Chemical Society, Year 1951, Volume 73, Issue 1, Page 373-380.

Physicochemical properties of the mesoporous silica particles with amine functions:
BET surface area: ˜700 m²/g;
Pore volume: ˜0.9 g/mL;
Pore diameter: ˜5 nm.

### Example 2: Adsorption/Desorption of Phenylalanine

Adsorption and desorption tests on a model molecule, phenylalanine (PhA) (one of the essential amino acids), were carried out to test the 3 MS-NH₂ obtained in Example 1.

Adsorption test (PhA@3MS-NH₂): 4 ml of phenylalanine solution at 0.8 g/l were mixed with 50 mg of 3 MS-NH₂ at neutral pH. After mixing for 24 h, the solid was separated from the supernatant using a magnet. The supernatant was analysed by dynamic light scattering (DLS, Malvern Nano ZS, UK) to verify the absence of 3MS-NH₂ particles. The liquid phase was titrated by UV-Visible spectrophotometry (Shimadzu, UV2550, Japan): about 79% of phenylalanine was adsorbed.

Desorption test: 50 mg of 3 MS-NH₂ on which the phenylalanine had been adsorbed (PhA@3MS-NH₂) were dispersed in 4 mL of water at pH 2. After mixing for 24 h, the solid phase was separated from the liquid phase using a magnet. The supernatant was analysed by DLS (Malverm, Nano, ZS, UK) to verify that there were no longer any particles in the liquid phase. The liquid phase was analysed by UV-Visible spectrophotometry: about 93% of initially adsorbed PhA was desorbed.

1. A method for preparing a functionalised magnetic mesoporous material based on silica 3MS-f, said method comprising the steps of:
i) hydrolysing and precondensing a precursor of silica (SiO₂) in an acid medium, in the presence of a porogen compound of formula (POE)ₙ-(POP)ₘ-(POE)ₙ wherein:
POE is a polyoxyethylene block,
POP is a polyoxypropylene block,
n is 20 or 106, and
m is 70;
ii) incorporating silica-coated superparamagnetic iron nanoparticles in the precondensed mixture obtained at step i), and continuing condensation;
iii) removing the porogenic agent from the condensed structure obtained, whereby an ordered magnetic mesoporous material based on silica 3MS is obtained; and
iv) functionalising the material 3MS obtained at the preceding step by covalently grafting at least one reactive function able to form a weak bond with at least one organic molecule of interest (OMI).

2. The method according to claim 1, wherein the silica precursor is a compound comprising at least one alkoxysilane group.

3. The method according to claim 1, wherein step ii) is conducted until obtaining a condensation rate of the silica precursor that is higher than or equal to 80%.

4. The method according to claim 1, wherein step iii) is performed by solvent extraction of the porogenic agent using a Soxhlet extractor.

5. The method according to claim 1, wherein said at least one reactive function is grafted at step iv) by contacting the material 3MS with a compound of formula:
(R³O)₄₋ₙSi-(L-X)ₙ (I)
where:
X is a reactive function chosen in from among:
a polar protic function chosen from among an amine or a carboxylic acid, phosphonic acid or sulfonic acid, and the salts thereof, or
a hydrophobic group chosen from among alkyl or aromatic groups,
L is a divalent spacer group chosen from among a bond, C₁-C₆ alkylene group, C₅-C₇ arylene group, aralkylene, alkylarylene group,
R³ is H or C₁-C₆ alkyl group, and
n is 1, 2 or 3.

6. A functionalised magnetic mesoporous material based on silica 3MS-f, obtained with the method as defined in claim 1.

7. A functionalised magnetic mesoporous material based on silica 3MS-f, characterised in that it comprises:
a) a mesoporous material of SBA-15 or SBA-16 type;
b) one or more silica-coated superparamagnetic iron particles;
c) at least one reactive function able to form a weak bond with at least one organic molecule of interest (OMI).

8. A non-functionalised magnetic mesoporous material based on silica 3MS obtained with steps i), ii) and iii) of the method as defined in claim 1.

9. The magnetic mesoporous material according to claim 6, wherein
the specific surface area S_{BET} of the material 3MS-f, measured with the BET method, is between 400 and 1000 m²/g,
the pore volume of the material is between 0.4 and 1.1 mL/g, or
the mean pore diameter is between 5 nm and 11 nm.

10. (canceled)

11. (canceled)

12. A method of using the functionalised 3MS-f magnetic mesoporous material based on silica according to claim 6, to isolate, concentrate or release an organic molecule of interest (OMI).

13. The method according to claim 12, wherein the organic molecule of interest (OMI) is chosen from among amino acids, polyphenols, polypeptides, proteins, and oligosaccharides (OS).

14. A method for isolating or concentrating an organic molecule of interest (OMI) comprising the steps of:
a) contacting the mixture comprising the OMI to be isolated or concentrated with a material 3MS-f as defined in claim 6; and
b) separating the mixture and recovering the material 3MS-(OMI) formed at the preceding step.

15. A magnetic mesoporous silica-based material 3MS-(OMI) obtained according to claim 14.

16. The method according to claim 1, further comprising the step of:
v) recovering the functionalised magnetic mesoporous material based on silica 3MS-f obtained at step (iv).

17. The method according to claim 1, wherein said weak bond is chosen from among electrostatic bonds between oppositely charged groups and hydrophobic bonds.

18. The method according to claim 2, wherein the silica precursor is a compound Si(OR)₄ with R being a C₁-C₄ alkyl group.

19. The magnetic mesoporous material according to claim 7, wherein said weak bond is chosen from among electrostatic bonds between oppositely charged groups and hydrophobic bonds.

20. The magnetic mesoporous material according to claim 19, wherein the hydrophobic bonds include phenyl.

21. The magnetic mesoporous material according to claim 8, wherein
the specific surface area S_{BET} of the material 3MS, measured with the BET method, is between 400 and 1000 m²/g,
the pore volume of the material is between 0.4 and 1.1 mL/g, or
the mean pore diameter is between 5 nm and 11 nm.

22. The method according to claim 14, further comprising the step of:
c) breaking the bond between the material 3MS and the (OMI), whereby the (OMI) is released and recovered, and the material 3MS-f is regenerated.
